(19) United States
(12) Patent Application Publication
(10) Pub. No.: US 2014/0012592 A1
(43) Pub. Date: Jan. 9, 2014

(54) SELECTING A SOLUTION

(71) Applicant: KONINKLIJKE PHILIPS N.V., EINDHOVEN (NL)

(72) Inventors: Ana Ivanovic, Eindhoven (NL); Kevin Michael Geary, Lynnfield, MA (US); Jan Johannes Gerardus De Vries, Eindhoven (NL)

(21) Appl. No.: 13/933,174

(22) Filed: Jul. 2, 2013

Related U.S. Application Data
(60) Provisional application No. 61/667,457, filed on Jul. 3, 2012.

(51) Int. Cl. G06Q 50/22; G06Q 10/06

(52) U.S. Cl. CPC G06Q 50/22; G06Q 10/06395
USPC 705/2

(57) ABSTRACT

A method of selecting a solution, comprises identifying a set of performance indicators that are correlated with a quality indicator. A target value is set for at least one of the performance indicators, based on a target in respect of the quality indicator. A plurality of solutions is selected, wherein a solution is associated with an effect on said at least one of the performance indicators for which a target value was set. At least one solution is selected of the plurality of solutions based on the target value of said at least one of the performance indicators and the effect of the selected at least one solution on said at least one of the performance indicators. A scenario is simulated with a particular value of at least one of the performance indicators, to obtain a predicted value of the quality indicator.

### FIELD OF THE INVENTION

The invention relates to reducing the number of readmissions in a healthcare institute, such as a hospital.

### BACKGROUND OF THE INVENTION

Discharged patients should be able to fully recover at home but according to the USA Centers for Medicare & Medicaid Services (CMS), 20% of discharged patents are re-hospitalized within 30 days. The statistics show that 50% of these readmissions may be preventable reaching cost of $17B per year in US. Moreover, readmission may cause discomfort for the patient. Consequently, it would be desirable to reduce the number of readmissions in a healthcare institute, such as a hospital.

Readmission services refer to a set of standard processes and tools used to identify root causes of preventable hospital readmissions and act upon findings to implement processes to reduce preventable rehospitalisation. Best practices for readmission services may aim at improving patient transitions from the hospital to post-acute care setting. However, there is no consensus as to the appropriate actions to take to reduce readmissions. Recommendations include improved discharge planning, setting-up early follow-ups and call centers or giving remote monitoring to patients. Although there is much evidence on what can be done to reduce readmission in general, it is not straightforward how to reduce readmission in a particular hospital as the evidence is neither compelling nor consistent.

There is a need for informed decisions on how to design an improvement program to reduce preventable readmission in a particular hospital.

Although in this description, emphasis is put on reduction of readmissions, it will be understood that similar difficulties may occur when trying to achieve other objectives in a hospital or in another kind of organization or project.

US 2011/0295622 A1 discloses preventing readmission by predicting the probability of a given patient to be readmitted. The probability alone may prevent readmission by educating the patient or medical professional. The probability may be predicted during a patient stay and used to generate a workflow action item to reduce the probability, to warn, to output appropriate instructions, and/or assist in avoiding readmission. The probability may be specific to a hospital, physician group, or other entity, allowing prevention to focus on past readmission causes for the given entity.

US 2011/0313788 A1 discloses using a readmission risk prediction model for identifying patients having elevated risk of readmission and determining inpatient treatment and outpatient activities based on readmission risk. Readmission risk prediction models may be generated for a variety of different clinical conditions using logistic regression techniques. When a patient is admitted to a hospital, the patient's condition is identified and a corresponding readmission risk prediction model is employed to identify the patient's risk of readmission. The readmission risk may be presented to a clinician and employed to recommend interventions intended to treat the patient and reduce the probability of readmission for the patient. The patient's readmission risk may also be calculated after the patient has been discharged and used for planning outpatient activities for the patient.

### SUMMARY OF THE INVENTION

It would be advantageous to have an improved method of reducing the number of readmissions in a healthcare institute. To better address this concern, a first aspect of the invention provides a method comprising

identifying a set of performance indicators that are correlated with a quality indicator;

setting a target value for at least one of the performance indicators, based on a target value of the quality indicator;

identifying a plurality of solutions, wherein a solution is associated with an effect on said at least one of the performance indicators for which a target value was set;

selecting at least one solution of the plurality of solutions based on the target value of said at least one of the performance indicators and the effect of the selected at least one solution on said at least one of the performance indicators.

The approach may result in improved selection of a solution for reducing the number of readmissions. Rather than selecting such a solution intuitively, solutions may be identified based on an effect on a performance indicator, and from among the identified solutions, at least one solution may be selected based on the effect of the solution.

The method may comprise simulating a scenario with a particular value of at least one of the performance indicators, to obtain a predicted value of the quality indicator, and wherein the setting of the target value is based on an outcome of the simulation. The simulation may result in more accurate setting of the target value.

The method may comprise assessing an impact of at least one of the identified plurality of solutions on at least one performance indicator. This helps to better evaluate the identified solution.

The method may comprise simulating a scenario using the assessed impact on said at least one performance indicator to obtain a prediction of an improvement of the quality indicator associated with the solution, and wherein the step of selecting is further based on the prediction of the improvement of the quality indicator associated with the solution. This may provide an improved selection.

The method may comprise assessing a cost of the identified at least one solution, and wherein the step of selecting is further based on the cost. This allows to take into account the cost when selecting a solution.

The method may comprise determining a measure based on a combination of the cost and an improvement of the quality indicator. This allows to make a cost/benefit analysis.

A solution of the plurality of solutions may comprise a combination of at least one product and/or service. This allows to predict the effect of introducing a product and/or service. Moreover, it allows to select a product and/or service in view of a particular goal. Moreover, it allows to select a combination of products and/or services in view of a particular goal.

The at least one product and/or service may comprise at least one of: a medical device, an information service, and a change in workflow. Such products and services may be particularly suited to be selected using the techniques disclosed herein. However, this is not a limitation.

The quality indicator may be indicative of a number of readmissions of discharged patients. The techniques disclosed herein may be particularly useful for a goal in respect of the number of readmissions of discharged patients. However, this is not a limitation.

In another aspect, the invention provides a computer program product comprising instructions for causing a processor system to perform the method set forth.

In another aspect, the invention provides a system for selecting a solution, comprising

a performance indicator unit for identifying a set of performance indicators that are correlated with a quality indicator;

a target unit for setting a target value for at least one of the performance indicators, based on a target value of the quality indicator;

a solution identifying unit for identifying a plurality of solutions, wherein a solution is associated with an effect on at least one of the performance indicators;

a solution selecting unit for selecting at least one solution of the plurality of solutions based on the target value of said at least one of the performance indicators and the effect of the selected at least one solution on said at least one of the performance indicators.

In another aspect, the invention provides a workstation comprising the system set forth.

In another aspect, the invention provides a computer server system comprising the system set forth.

It will be appreciated by those skilled in the art that two or more of the above-mentioned embodiments, implementations, and/or aspects of the invention may be combined in any way deemed useful.

Modifications and variations of the system, the workstation, the server system, and/or the computer program product, which correspond to the described modifications and variations of the method, can be carried out by a person skilled in the art on the basis of the present description.

### BRIEF DESCRIPTION OF THE DRAWINGS

These and other aspects of the invention are apparent from and will be elucidated hereinafter with reference to the drawings.

FIG. 1 is a flowchart of a method of selecting a solution for reducing readmissions in a healthcare institute.

FIG. 2 is a block diagram of a system for selecting such a solution.

FIG. 3 illustrates another example of a method according to the invention.

### DETAILED DESCRIPTION OF EMBODIMENTS

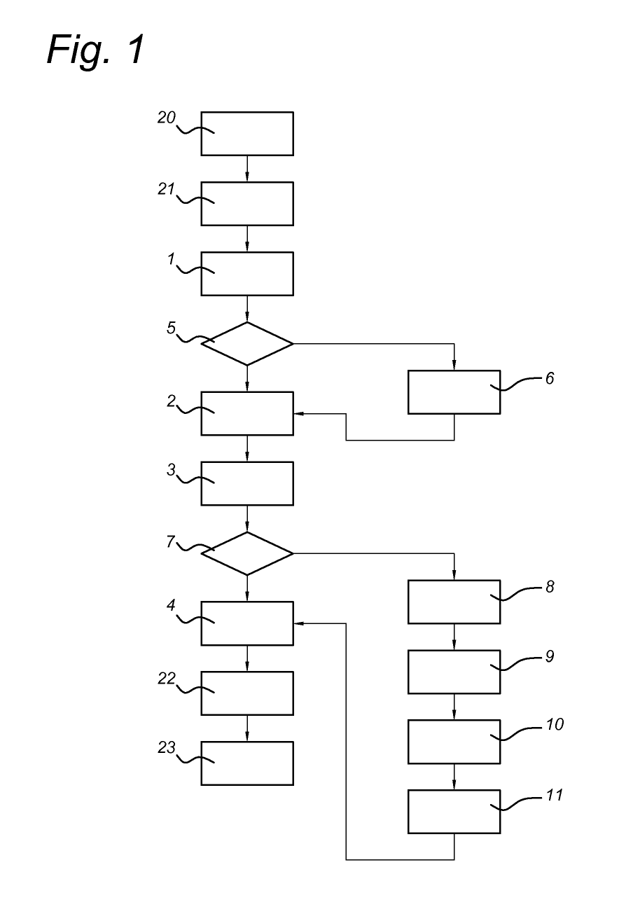

FIG. 1 illustrates an example of a method for reducing a number of readmissions according to the invention. The method may be implemented as a computer program product. Such a computer program product may be operative on a workstation or server system. When implemented on a server system, an interface to at least one workstation or any other kind of user terminal may be provided to enable the user to provide inputs and/or review results.

The method may have access to a representation of a plurality of performance indicators and their correlation with a quality indicator. Performance indicators may also be referred to as key performance indicators. The method may comprise a first step 20 of identifying a plurality of performance indicators. For example, a representation of these performance indicators may be provided in a database. The performance indicators may be stored together with additional information, such as statistical information. Such information could comprise a correlation of a performance indicator with another performance indicator or a quality indicator. These correlations may be obtained may means of simulation or by a statistical analysis of historical information collected by one or more organizations. Examples of performance indicators may include clinical, operational, or financial performance indicators, as will be elucidated elsewhere in this description.

The method may comprise a next step 21 of identifying a quality indicator, and setting a target for the quality indicator. The quality indicator may be one of the performance indicators. Alternatively, it is a separate variable that does not appear among the plurality of performance indicators. The quality indicator may represent a numerical value. Alternatively, the quality indicator may represent a category, such as low/medium/high. For example, a user may select the quality indicator. Moreover, the user may select a target in respect of the selected quality indicator. For example, a target may be a decrease or an increase of the quality indicator. The target may also comprise a target value of the quality indicator.

The method may comprise a step 1 of identifying a set of performance indicators from the plurality of performance indicators. This step may be performed by selecting the set of performance indicators such that each selected performance indicator is correlated with the quality indicator. This correlation may be pre-computed, and stored in the database, as discussed above. Alternatively, the correlation may be established by means of on-the-spot calculations.

The method may proceed with a step 2 of setting a target value for at least one performance indicator of the set of performance indicators. This target value is set based on a target in respect of the quality indicator. For example, if the target in respect of the quality indicator involves a target value, a target value of the performance indicator may be selected that corresponds to the target value of the quality indicator. Alternatively, if the target involves a decrease or an increase of the quality indicator, a target value of the performance indicator may be set that corresponds to such an increase or decrease of the quality indicator. Other kinds of targets may be treated accordingly.

The method may proceed with step 3 of identifying a plurality of solutions. To this end, a plurality of solutions may be selected from a collection of available solutions. Such a collection may be available by means of a database with descriptions of solutions. Such descriptions may be accompanied with statistical or other information in respect of what is known about the effects of such solutions. The database may also comprise a representation of a collection of components. These components may also be accompanied by information about their effect. The method may select any combination of these components to form a solution. Constraints on possible combinations of components may also be provided. The information relating to the effect of the solutions and/or components may be used to associate the selected solution with an effect on said at least one of the performance indicators for which a target value was set.

The method may proceed with step 4 of selecting at least one solution of the plurality of solutions. This selection may be made based on the target value of said at least one of the performance indicators. Moreover, the effect of the selected at least one solution on said at least one of the performance indicators may be taken into account in the selection.

The method may proceed with step 22 of presenting the selected at least one solution. This may be done by means of a display device, on which an indication of the solution is displayed. However, the solution may be presented in any possible way, including video clip and/or verbal communication. For example, the solution may be presented to a hospital management so that they can make an informed decision about the proposed solution.

Alternatively and/or additionally to step 22, the method may proceed with step 23 of implementing the selected solution. This step 23 may be performed automatically, in particular if the solution involves the use of software or the modification of a change to a computer-enforced workflow. Alternatively, the step 23 of implementing the solution may be performed by humans, for example by acquiring the associated products and/or services and deploying them throughout the organization, and by instructing the personnel to work according to the proposed solution.

The method may comprise a step 6 of simulating a scenario with a particular value of at least one of the performance indicators. This simulation may provide a predicted value of the quality indicator. In the step 2 of setting the target value, the outcome of the simulation, such as the predicted value of the quality indicator, may be taken into account. For example, the method comprises a step 5 after step 1, in which it is determined whether the simulation of step 6 should be performed, or whether the method should proceed directly with step 2. This may be a pre-programmed choice, or it may be a configurable option.

The method may comprise a step 7, after step 3, of determining whether the impact of a solution on at least one of the performance indicators should be assessed. This choice may be pre-programmed or configurable. If it is determined in step 7 that this impact should not be assessed, for example because the effect of the solution on the performance indicators is already known to a sufficient extent, then the method proceeds at step 4.

If it is determined that the impact should be assessed, the method may proceed at step 8 with assessing an impact of at least one of the identified plurality of solutions on at least one performance indicator. This impact may be assessed, for example, by means of a model of the solutions (or components of solutions) and impacts. For example, the database of solutions and/or components may store for each solution and/or component a representation of a predicted impact on or a correlation with at least one performance indicator.

After step 8, the method may proceed with step 9 comprising simulating a scenario using the assessed impact on said at least one performance indicator. The simulation provides a prediction of a change of the quality indicator associated with the solution. Typically, this change represents an improvement. The step 4 of selecting may be performed taking into account the prediction of the change to the quality indicator associated with the solution. The simulation may be performed using a model of the system involving the performance indicators and quality indicator as variables.

Besides step 8 and 9, the method may also include step 10 of assessing a cost of the identified at least one solution. This step may be performed independently of the impact of the solution on the performance indicators. Moreover, this step may be performed regardless of whether the impact is assessed and the simulation thereof is performed. The step 4 of selecting may be performed taking into account the cost of the solution.

Having established the cost of the solution, as well as the change to the quality indicator, the method may proceed with step 11 of determining a measure based on a combination of the cost and an improvement of the quality indicator. For example, the measure may comprise a ratio of both entities. The selection of step 4 may be based on this measure.

The selected solution, as well as any or all of the other solutions, may comprise a combination of at least one product and/or service. Examples of such products are a medical device, a pharmaceutical, and a computer program. Examples of such services are an information service or a management service to implement a change in workflow. Further examples of components of solutions include a project management tool, a management change, a medication dispenser, a medical imaging apparatus, a clinical decision support system, a change in workflow, a scheduling system, a patient monitoring system, a patient sensing device, a personal clinical or social service, an educational tool, a medical therapy devices and/or service, a self-management care tool, a video and/or audio consultation, and a personalized clinical consultation schedule.

The quality indicator may be indicative of a number of readmissions of discharged patients. This example is elaborated hereinafter. However, it is not a limitation.

The method may be implemented by means of a computer program product. Steps of the method may also be performed manually. For example, the computer program may provide a user interface to request specific input that is used in the method. For example, the solutions for which a simulation is performed, may be selected manually. This may reduce the computational efforts needed, because a simulation may be computationally expensive.

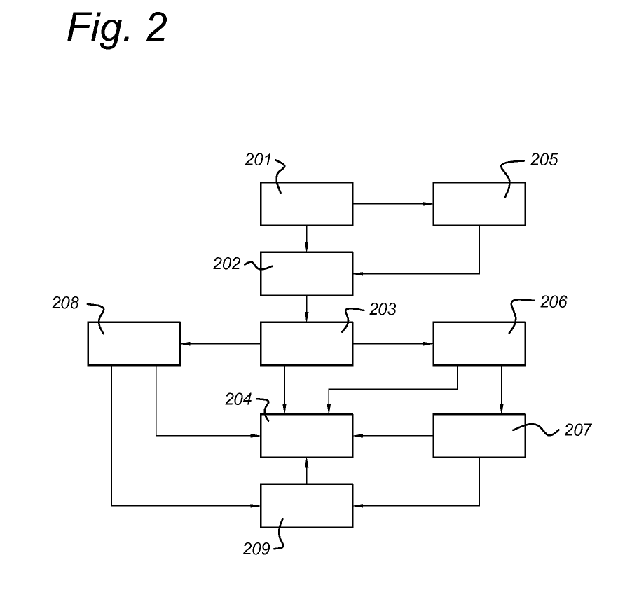

FIG. 2 illustrates a system for selecting a solution. The system may be implemented on a computer system, such as a workstation or server. The system may also be implemented using dedicated electronic circuitry. The system may comprise a communications port, to enable communication with external sources, such as external information storage and retrieval systems and/or a simulation engine that is capable to perform some or all of the simulations described herein. The system may also comprise local storage. The system may also comprise the simulation engine.

The system may comprise a performance indicator unit 201 for identifying a set of performance indicators that are correlated with a quality indicator. The system may further comprise a target unit 202 for setting a target value for at least one of the performance indicators, based on a target value of the quality indicator. The system may further comprise a solution identifying unit 203 for identifying a plurality of solutions. In general, a solution may be associated with an effect on at least one of the performance indicators. The system may further comprise a solution selecting unit 204 for selecting at least one solution of the plurality of solutions based on the target value of said at least one of the performance indicators and the effect of the selected at least one solution on said at least one of the performance indicators.

The system may further comprise a performance simulator 205 for simulating a scenario with a particular value of at least one of the performance indicators. This way, a predicted value of the quality indicator may be obtained. The target unit 202 may be arranged for setting the target value based on an outcome of the simulation.

The system may further comprise an impact assessment unit 206 for assessing an impact of at least one of the identified plurality of solutions on at least one performance indicator.

The system may further comprise an impact simulator 207 for simulating a scenario using the assessed impact on said at least one performance indicator to obtain a prediction of a change to the quality indicator associated with the solution. The solution selecting unit 204 may be arranged for selecting the solution further based on the prediction of the improvement of the quality indicator associated with the solution.

The system may further comprise a cost assessment unit 208 for assessing a cost of the identified at least one solution. The solution selecting unit 204 may be arranged for selecting the solution further based on the cost.

The system may further comprise a measure unit 209 for determining a measure based on a combination of the cost and a change to the quality indicator induced by the identified at least one solution.

The system may comprise additional units and/or the functionality may be divided into logical units in a different way. Moreover, the system may be extended and/or modified based on the functionality described in respect of the method and/or elsewhere in this description.

Hospitals may control clinical processes by establishing a set of key performance indicators (KPIs), also referred to as “performance indicators”. These indicators can include a broad set of clinical (e.g. readmission rate), operational (e.g. length of stay, LoS), or financial (e.g. Revenue) performance indicators that may be selected to benchmark with other hospitals or to monitor internal processes to reach desired KPI targets. KPIs are monitored and analyzed by hospital management (e.g. monthly or quarterly) and if there are unexpected trends over time, the hospital management may reevaluate their strategy on how to reach performance targets. Despite the importance to reduce readmission, readmission rates are not a single objective of the hospital, but may be considered and balanced with other hospital objectives that might be conflicting. For example, one way to reduce readmission is to increase length of the patient stay in hospital to stabilize the patient. However, increasing the length of stay conflicts another business objective of reducing in-hospital cost. Therefore, readmission rates may be considered by balancing a set of KPIs that reduce readmission rate and proposing realistic improvements programs and targets to support hospital's objectives.

However, the improvement program with targeted KPIs can be executed in different ways and hospital executives may seek for a cost-effective turn-key solution with expectation on how much and within which time period improvements will affect readmission rate and/or other objectives. When a solution is proposed, for example by a service provider or vendor, the techniques disclosed herein may help to predict an impact of the proposed solution on quality indicators, such as readmission rate and value (cost savings) generated in a hospital. Moreover, the techniques may help to select an appropriate solution.

To support a healthcare organization, a two-stage program may be applied. The first stage provides a four-step approach to identify relevant KPIs, simulate the impact of KPI changes on readmission, and provide recommendations on KPIs targets to reduce readmission. The second stage provides a multi-step approach to propose a viable solution for readmission management to meet targets identified in the first stage with evidence of how different proposals could reduce readmissions (or affect another quality indicator). These proposals may help to show which solution is a viable option to obtain the desired effect on the quality indicator, such as reducing readmission rates. Hereinafter, the stages are elaborated for the example of a hospital and readmission reduction as the criterion. It will be understood that the example may also be applied for other organization or systems than a hospital. Moreover, it will be understood that the example may also be applied to other targets than readmission reduction. The skilled person is capable of making the necessary changes.

In more detail, the first stage may comprise any one or more of the following steps:
1. Identify the main objectives of the hospital and a targeted readmission reduction.
2. Identify the KPIs which predict readmission reduction based on the hospital data.
3. Simulate scenarios with the targeted KPI improvements that impact readmission reduction significantly and select the top three scenarios, which reach the targeted readmission rate identified in step 1.
4. Provide recommendation on how to bundle KPI targets to reduce readmission to the targeted value reviewing the objectives in step 1, optionally in consensus with hospital stakeholders.

The second stage may comprise any one or more of the following steps:
1. Propose a list of solution options to meet KPI targets identified in the first stage (step 4).
2. Assess an impact of the solution options on KPIs; simulate an impact on readmission rate using a simulator. This may be the same simulator of step 3 of the first stage, or a different simulator.
3. Assess investment versus readmission rate reduction ratios available to the hospital by using the various proposed solutions.
4. Recommend the optimal solution.

The techniques disclosed herein may be applied at least in part by:
Consultants. Consultants may use the method to control the two-stage process.
Expert teams. Experts in hospital processes and solutions may help proposing a solution as a bundle of readmission services for a particular hospital. Hereinafter, the term ‘consultant’ will be used to denote either a single consultant or an expert team comprising consultants.
Hospital teams. Hospital teams may comprise a hospital's decisions makers (e.g. a board, department heads) that are given recommendation by the consultant and/or expert team to make an informed decision on improvement programs for readmission reduction.

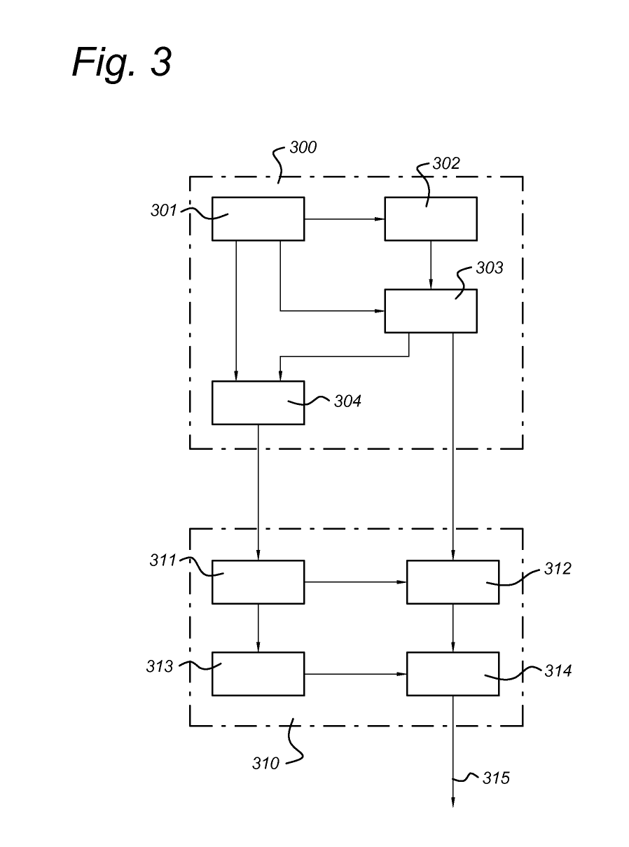

FIG. 3 illustrates two-stage process with enumerated steps. The figure is explained using an example of how a consultant advises a hospital to control readmission.

In the first stage 300, the consultant helps the hospital to make an informed decision on how to reduce readmission with KPI management by simulating the impact of KPI targets on readmission rate reduction. Hereinafter, the first stage will be elucidated with more detail by means of example.

In step 301, the consultant presents the consultancy program to the hospital team. Then the hospital and the consultant identify main objectives of the hospital including the readmission reduction target. In this step, the hospital team also presents the current measures used to monitor hospital operational and clinical excellence to reach objectives, the so-called KPIs. For example strategy map and balanced scorecards may be used to support such a process (workshops).

Example: The hospital has main objective is to reduce readmission for heart failure patients by at least 5% by increasing adherence to clinical guidance AND without changing a workflow.

In step 302, the consultant is provided with the KPIs identified in step 301 and their values that have been collected over the year(s) by the hospital. Potentially, this dataset can be extended with data gathered from other hospitals. By running statistical analysis tools, the consultant identifies those KPIs, which are among the strongest readmission predictors. The data analysis may follow the following structure, and/or comprise any one or more of the following:
1) Using the KPI-values provided, create mathematical/statistical models of individual KPIs to represent readmission rates and/or create models combining multiple KPIs and their correspondence with readmission.
   a) This can be obtained through linear regression, non-linear regression, machine learning techniques (such as neural networks), etc.
   b) Either way, the mathematical models that result from a function that maps a (sub)set of KPIs to a predicted readmission rate, which may have the form of: R=f({KPI}).
2) Determine the correspondence (e.g., correlation) between models and readmission rates.
   a) The correspondence of the models is also a measure of quality that should be taken into account in the further process. Statistical methods also allow for the specification of confidence intervals. These intervals can in a later stage be used to indicate the confidence of simulated situations with altered KPI-values.
3) Choose the best corresponding models to represent readmission.
4) Using this set of best predicting models, reformulate the functions that represent the models to express the KPI-value(s) in terms of the readmission risk.
   a) That is, rewrite R=f({KPl}) as KPl₁=f⁻¹(R₁{KPI₁∥=l}).
5) Using the rewritten functions, study the influence of KPIs on readmission rate by calculating the KPI-values that correspond to a target readmission rate (R).
   a) In case of models using single KPIs the rewritten function does not contain further variables and can directly be used to calculate the target-value of the KPI.
   b) In case of models using multiple KPIs, the rewritten function(s) do(es) not only depend on the target readmission rate, but also on the other KPIs within the model. The result, however, is a function that describes the value of KPIs relative to each other. The most feasible combination of KPI-values can be chosen while taking into account restrictions from the hospital. For example, the model indicates a particular ratio between two KPIs as being relevant for a particular target readmission rate, then the chosen KPI-target-values may take into account the limitations of the hospital.

In the example, it is assumed that the main predictors of heart failure (HF) readmission in the hospital are:
Nr. of patients that are prescribed ACEIs medications
Nr. of patients with smoking cessation
Nr of patients that have been scheduled follow-up appointments
Discharged on Friday
Nr. of patients discharged from 11-12:00
Patients having a memory loss
Patients with lower literacy
   These predictors reduce the solution space to KPIs improvements that make an impact on the readmission reduction.

In step 303, feasible scenarios are defined with KPIs targets to reach readmission reduction aligned with the objectives. Scenarios set up a scene for proposing feasible improvement programs aimed at improving predefined KPIs in the next stage of the process (the second stage).

The feasible scenarios may not exactly match the found optimal KPI-target setting. Nevertheless, the scenario's that would lead to KPI-values closest to the found KPI-targets can be chosen. Furthermore, the models found in step 302 can be used to study the influence of non-optimal KPI-values in terms of expected readmission rate. During this simulation process, simulated KPI-values may be inputted into the model, which delivers the expected readmission rate. An optimal setting can be obtained by reflecting with the target readmission rate. During this process the quality of the models should be taken into account.

The confidence intervals determined during the model-creation indicate the accuracy of the prediction made during this step. Depending on the wishes of the hospital, a different model might be chosen that expects larger improvements though with larger risk or models with less risk of miss-prediction.

Example: If the objective is to reduce readmission for heart failure patients at least 5% by increasing adherence to clinical guidance without changing a workflow (step 1), the scenarios may elaborate on KPI targets (step 2) feasible to address in the improvement program. One scenario could be to address KPI-predictors that monitor adherence to guidance such as the above-mentioned predictors, perhaps excluding the Discharge on Friday and Between 11:00-12:00, as these would be associated with workflow changes, and workflow changes were indicated to be undesirable by the hospital. A bundle of KPI targets is simulated to reach readmission reduction of 5%, resulting in a particular set of target-values for the KPIs.

In step 304, the consultant presents to the hospital team what has been agreed in objectives (step 1) and what are feasible KPIs targets given the objectives (step 3). In the open discussion the hospital teams reflects on the results and makes an informed decision on whether to pursue one of the scenarios to improve readmission rate themselves or by contracting the same or another consultant to help in the next stage.

Example: Based on the analysis of the consultant, the hospital agrees on the scenario propose an improvement program to improve KPIs related to:
Nr. of patients that are prescribed ACEIs medications (current 65%, target 85%)
Nr. of patients with smoking cessation (current 48%, target 65%)
Nr of patients that have been scheduled follow-up appointments (current 48%, target 65%)
Discharge on Friday
Nr. of patients discharged from 11-12:00
Nr. of patients having a memory loss
Nr. of patients with lower literacy.

In the second stage, the consultant helps the hospital to make an informed decision on investing in improvement programs to reduce readmission by using a particular solution, wherein the solution may comprise several services and products.

In step 311, the consultant bundles a feasible solution to address improvements of the targeted KPIs. Such a proposal or solution may comprise a complete service offering including: project management, change management, and technology solutions.

Example: In the case described above, there are already KPIs identified for reducing readmission. Now the consultant may map services or/and products to KPIs targets. For example, for the identified targets, the consultant can propose different technology solutions such as:
Discharge planning tool that will help care providers to adhere to the guidance and improve item 1 and 3.
An education module on the Care Servant administrating planning tool.

In step 312, the consultant may use historical data of the hospital to predict how much a proposed solution will reduce the readmission rate. Different solutions may have different impact on readmission rate.

In step 313, the consultant may calculate the value of implementing the proposed solution based on (i) the value generated by avoiding a financial penalty by reducing readmission (a readmission rate reduction may be predicted in step 312) and (ii) the cost of purchasing a technology product and/or consultancy service associated with a solution, as well as any other cost associated with the solution.

In step 314, the consultant presents the solutions for readmission management (step 311), expected readmission reductions (step 312) and expected value of the solution to the hospital team (step 313). This is indicated by arrow 315. The hospital management team uses the results to make an informed decision on investing in the best readmission control solution.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a flash drive or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method of reducing a number of readmissions in a healthcare institute, comprising
identifying a set of performance indicators that are correlated with a quality indicator indicative of the number of readmissions;
setting a target value for at least one of the performance indicators, based on a target in respect of the quality indicator;
identifying a plurality of solutions, wherein a solution is associated with an effect on said at least one of the performance indicators for which a target value was set;
selecting at least one solution of the plurality of solutions based on the target value of said at least one of the performance indicators and the effect of the selected at least one solution on said at least one of the performance indicators.

2. The method according to claim 1, further comprising simulating a scenario with a particular value of at least one of the performance indicators, to obtain a predicted value of the quality indicator, and wherein the setting of the target value is based on an outcome of the simulation.

3. The method according to claim 1, further comprising assessing an impact of at least one of the identified plurality of solutions on at least one performance indicator.

4. The method according to claim 3, further comprising simulating a scenario using the assessed impact on said at least one performance indicator to obtain a prediction of a change to the quality indicator associated with the solution, and wherein the step of selecting is further based on the prediction of the improvement of the quality indicator associated with the solution.

5. The method according to claim 1, further comprising assessing a cost of the identified at least one solution, and wherein the step of selecting is further based on the cost.

6. The method according to claim 5, further comprising determining a measure based on a combination of the cost and a change to the quality indicator induced by the identified at least one solution.

7. The method according to claim 1, wherein a solution of the plurality of solutions comprises a combination of at least one product and/or service.

8. The method according to claim 7, wherein the at least one product and/or service comprises at least one of: a medical device, an information service, and a change in workflow.

9. A computer program product comprising instructions for causing a processor system to perform the method according to claim 1.

10. A system for selecting a solution, comprising
a performance indicator unit for identifying a set of performance indicators that are correlated with a quality indicator;
a target unit for setting a target value for at least one of the performance indicators, based on a target value of the quality indicator;
a solution identifying unit for identifying a plurality of solutions, wherein a solution is associated with an effect on at least one of the performance indicators;
a solution selecting unit for selecting at least one solution of the plurality of solutions based on the target value of said at least one of the performance indicators and the effect of the selected at least one solution on said at least one of the performance indicators.

11. A workstation comprising the system according to claim 11.

12. A computer server system comprising the system according to claim 11.
